(19) United States
(12) Patent Application Publication
(10) Pub. No.: US 2025/0131592 A1
(43) Pub. Date: Apr. 24, 2025

(54) ARRANGING APPARATUS FOR ARRANGING CG MODEL, DISPLAY APPARATUS, AND ARRANGING METHOD

(71) Applicant: CANON KABUSHIKI KAISHA, Tokyo (JP)

(72) Inventor: KAZUKI TAKEMOTO, Kanagawa (JP)

(21) Appl. No.: 18/911,680

(22) Filed: Oct. 10, 2024

(30) Foreign Application Priority Data
Oct. 19, 2023 (JP) 2023-180060

(51) Int. Cl. G06T 7/73; G06T 19/00

(52) U.S. Cl. CPC G06T 7/75; G06T 19/00; G06T 2207/30204

(57) ABSTRACT

An arranging apparatus arranges a CG model with a shape approximately matching a shape of an object in a specific space so that the CG model overlaps with the object. The arranging apparatus acquires three-dimensional positions of a plurality of markers arranged on a first object. The arranging apparatus selects a first CG model of which a shape approximately matches a shape of the first object based on the three-dimensional positions of the plurality of markers. The arranging apparatus estimates a relationship of relative positions and attitudes between the selected first CG model and the first object based on the three-dimensional positions of the plurality of markers. The arranging apparatus arranges the first CG model in the specific space so as to overlap with the first object based on the estimated relationship of positions and attitudes.

### BACKGROUND OF THE INVENTION

### Field of the Invention

The present invention relates to an arranging apparatus of a CG model, a display apparatus, and an arranging method.

### Description of the Related Art

Conventionally, a system that draws a CG (computer graphics) model according to a movement of a display device superimposes and displays the CG model on an object held in a hand of an experiencer or an object that moves in a real space. In such a system, it is important to control the CG model at an appropriate position and attitude in accordance with a position and attitude of the object.

U.S. Pat. No. 10,817,724 describes a technique of mounting a distance sensor to a system and calculating a relationship of positions and attitudes between an object and a CG model based on a distance image obtained from the distance sensor and a depth value of the CG model.

However, in U.S. Pat. No. 10,817,724, a user must select the CG model corresponding to the object and there are cases where an estimation of the relationship between the position and attitude of the object and the position and attitude of the CG model cannot be realized in a more efficient manner.

### SUMMARY OF THE INVENTION

In consideration thereof, an object of the present invention is to realize an estimation of a relationship between a position and attitude of an object and a position and attitude of a CG model in an efficient manner.

An aspect of the present invention is an arranging apparatus which arranges a CG model in a specific space so that the CG model overlaps with an object, the arranging apparatus including one or more processors and/or circuitry configured to: execute position acquisition processing of acquiring three-dimensional positions of a plurality of markers arranged on a first object; execute selection processing of selecting a first CG model from a plurality of CG models based on the three-dimensional positions of the plurality of markers; execute estimation processing of estimating a relationship of relative positions and attitudes between the first CG model selected by the selection processing and the first object based on the three-dimensional positions of the plurality of markers; and execute arrangement processing of arranging the first CG model in the specific space so as to overlap with the first object based on the relationship of positions and attitudes estimated by the estimation processing.

An aspect of the present invention is a display apparatus which displays an image of a CG model so that the CG model overlaps with an object, the display apparatus including one or more processors and/or circuitry configured to: execute position acquisition processing of acquiring three-dimensional positions of a plurality of markers arranged on a first object; execute selection processing of selecting a first CG model from a plurality of CG models based on the three-dimensional positions of the plurality of markers; execute estimation processing of estimating a relationship of relative positions and attitudes between the first CG model selected by the selection processing and the first object based on the three-dimensional positions of the plurality of markers; execute arrangement processing of arranging the first CG model so as to overlap with the first object based on the relationship of positions and attitudes estimated by the estimation processing; and execute display processing of displaying an image of the first CG model arranged by the arrangement processing.

An aspect of the present invention is an arranging method of arranging a CG model in a specific space so that the CG model overlaps with an object, the arranging method including: executing position acquisition processing of acquiring three-dimensional positions of a plurality of markers arranged on a first object; executing selection processing of selecting a first CG model from a plurality of CG models based on the three-dimensional positions of the plurality of markers; executing estimation processing of estimating a relationship of relative positions and attitudes between the first CG model selected in the selection processing and the first object based on the three-dimensional positions of the plurality of markers; and executing arrangement processing of arranging the first CG model in the specific space so as to overlap with the first object based on the relationship of positions and attitudes estimated in the estimation processing.

Further features of the present invention will become apparent from the following description of exemplary embodiments with reference to the attached drawings.

### BRIEF DESCRIPTION OF THE DRAWINGS

FIG. 1 is a block diagram of an HMD according to a first embodiment;

FIG. 2 is an internal configuration diagram of an alignment estimating unit according to the first embodiment;

FIG. 3 is a flow chart of display processing of a composite image according to the first embodiment;

FIG. 4 is a flow chart of processing by the alignment estimating unit according to the first embodiment;

FIG. 5 is a diagram representing a mixed reality space according to the first embodiment;

FIG. 6 is a hardware configuration diagram of the HMD according to the first embodiment;

FIG. 7 is an internal configuration diagram of an alignment estimating unit according to a second embodiment;

FIG. 8 is a flow chart of display processing of a composite image according to the second embodiment;

FIG. 9 is a flow chart of processing by the alignment estimating unit according to the second embodiment;

FIG. 10 is a block diagram of an HMD according to a third embodiment;

FIG. 11 is a diagram illustrating association of group IDs according to the first embodiment;

FIG. 12 is a diagram illustrating a marker rectangular parallelepiped according to the first embodiment;

FIGS. 13A and 13B are diagrams illustrating an estimation of alignment information according to the first embodiment; and

FIGS. 14A and 14B are diagrams illustrating marker information and feature point information.

### DESCRIPTION OF THE EMBODIMENTS

Hereinafter, embodiments of the present invention will be described in detail with reference to the accompanying drawings. Hereinafter, an object which is arranged in a real space and which can be moved by an experiencer (user) will be referred to as a “movable object”.

### First Embodiment

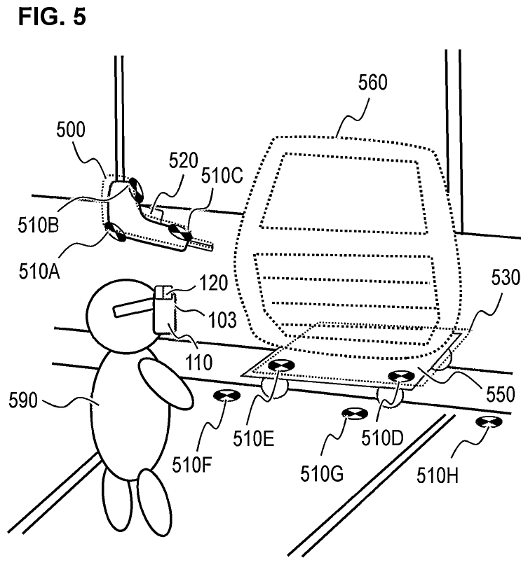

FIG. 5 represents a mixed reality space (MR space) in which an experiencer 590 is to have an MR experience. FIG. 5 is a schematic view showing a relationship among the experiencer 590 wearing an HMD 1, a tool 520, a pedestal 550, a virtual tool 500, a virtual component 560, and a virtual pedestal 530 on which the virtual component 560 is to be placed. In the mixed reality space, there is an object arranged in real space and a virtual object (CG model) which is virtually expressed. The experiencer 590, the tool 520, and the pedestal 550 are objects actually arranged in real space. The virtual tool 500, the virtual pedestal 530, and the virtual component 560 are virtual objects (CG models). The virtual pedestal 530 and the virtual component 560 are objects that are interlocked with each other.

The virtual tool 500 is arranged so as to overlap with the tool 520. The virtual pedestal 530 is arranged so as to overlap with the pedestal 550. By looking at a display unit 110 of the HMD 1 worn on his/her head, the experiencer 590 can view an image in which the virtual tool 500, the virtual pedestal 530, and the virtual component 560 are composited on a captured image (an image of real space captured by an imaging unit 103).

In the first embodiment, as shown in FIG. 5, a plurality of markers 510 (markers 510A to 510E) used to composite a virtual object on an object in real space without causing a sense of discomfort are arranged on (fixed to) the tool 520 and the pedestal 550.

For example, the markers 510 are rectangular indicators with an ArUco-based identification ID of which a detection function is provided in the OpenCV library. Note that the shape of the markers 510 is not limited to being rectangular in the first embodiment. The shape of the markers 510 may be any shape as long as positions of center points of the markers 510 can be measured based on a plurality of images acquired by the imaging unit 103.

### Configuration of HMD

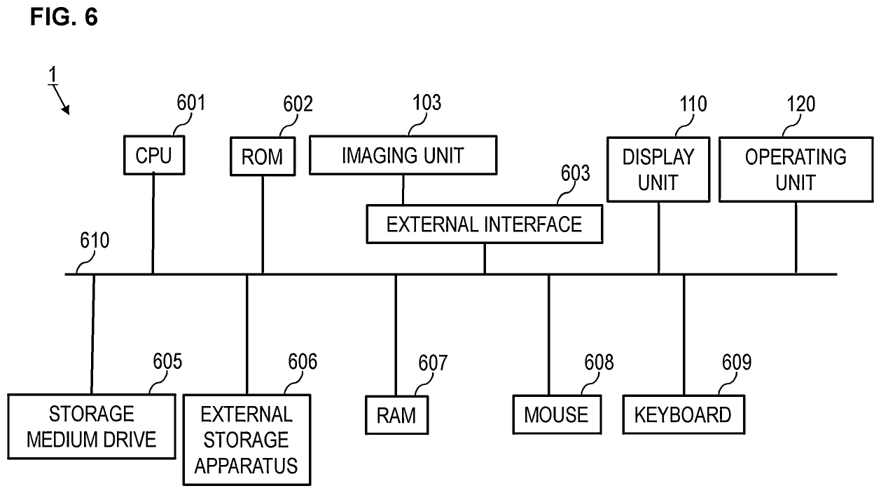

FIG. 6 is a hardware configuration diagram of the HMD 1 according to the first embodiment. The HMD 1 includes a CPU 601, a ROM 602, an external interface 603, a storage medium drive 605, an external storage apparatus 606, a RAM 607, a mouse 608, a keyboard 609, and a system bus 610. In addition, the HMD 1 includes the imaging unit 103, the display unit 110, and an operating unit 120.

The CPU (Central Processing Unit) 601 is a control unit that controls the entire HMD 1.

The ROM 602 is a Read Only Memory that stores programs and parameters which need not be changed. The ROM 602 stores a predetermined information processing program as a program code that can be read by the CPU 601. Processing indicated by the program code is to be executed by the CPU 601.

The external interface 603 transmits and receives image signals and files to and from the imaging unit 103.

The storage medium drive 605 is an apparatus that saves data on a permanent basis. The storage medium drive 605 records data on a physical medium or reads data recorded on the physical medium.

The external storage apparatus 606 is an external storage apparatus installed inside the HMD 1. Alternatively, the external storage apparatus 606 is an external storage apparatus that can be attached to and detached from the HMD 1. The external storage apparatus 606 includes a hard disk, a flash memory, a floppy disk (FD), an optical disk (such as a Compact Disc (CD)), a magnetic card, an optical card, an IC card, a memory card, or the like. A moving image file or the like acquired by the imaging unit 103 is written to the external storage apparatus 606.

The RAM 607 is a Random Access Memory (RAM) that temporarily stores programs and data supplied from an external apparatus or the like.

The mouse 608 and the keyboard 609 are operating members used by the user to give instructions to the HMD 1.

The system bus 610 is a system bus that interconnects the respective components so as to be capable of communicating with each other.

The imaging unit 103 is a camera which, for example, acquires an image (hereinafter, referred to as a “camera image”) by imaging a scene in real space. The imaging unit 103 may be a color camera or a monochromatic camera. Alternatively, a stereoscopic camera for displaying a stereoscopic image on the HMD 1 may be used as the imaging unit 103. In the first embodiment, the imaging unit 103 is assumed to be a stereoscopic camera in order to arrange a display panel near both eyes of the experiencer 590. The imaging unit 103 outputs a camera image to a model arranging apparatus 100 to be described later.

The display unit 110 is a device (display apparatus) that displays images. In the first embodiment, a display mounted to the HMD 1 is used as the display unit 110. Note that an external monitor arranged outside of the HMD1 may be used as the display unit 110 instead of the HMD 1. The display unit 110 may simultaneously display a same image on the display of the HMD 1 and on the external monitor.

The operating unit 120 is a device provided for the experiencer 590 to issue instructions. For example, the operating unit 120 may be a button. The operating unit 120 may include the mouse 608 or the keyboard 609.

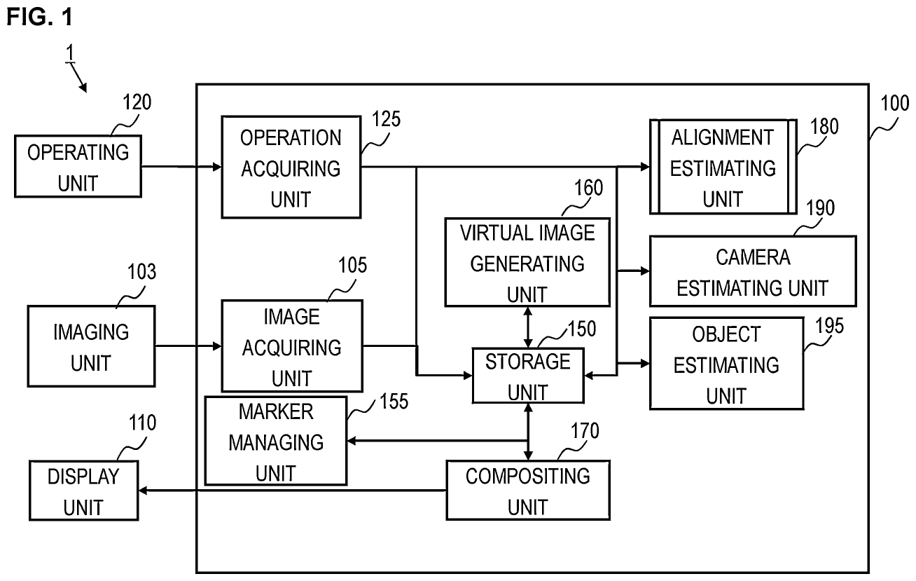

FIG. 1 is a block diagram of the HMD 1 that is worn on the head of the experiencer 590. The HMD 1 includes the model arranging apparatus 100, the imaging unit 103, the display unit 110, and the operating unit 120.

The model arranging apparatus 100 generates an image representing a composite space in which a CG model is arranged in a real space. The model arranging apparatus 100 is an information processing apparatus such as a personal computer, a smartphone, or a server on the cloud. The model arranging apparatus 100 is connected to the imaging unit 103, the display unit 110, and the operating unit 120.

Therefore, the model arranging apparatus 100 has a hardware configuration excluding “the imaging unit 103, the display unit 110, and the operating unit 120” of the HMD 1 shown in FIG. 6.

### Configuration of Model Arranging Apparatus

FIG. 1 is a diagram showing a functional configuration of the model arranging apparatus 100. The model arranging apparatus 100 includes an image acquiring unit 105, an operation acquiring unit 125, a storage unit 150, a marker managing unit 155, a compositing unit 170, an alignment estimating unit 180, a camera estimating unit 190, and an object estimating unit 195.

The image acquiring unit 105 acquires a camera image from the imaging unit 103 and stores the camera image in the storage unit 150.

The operation acquiring unit 125 outputs a signal indicating an operation accepted by the operating unit 120 to the storage unit 150 or the alignment estimating unit 180.

The storage unit 150 is constituted of the RAM 607. Therefore, the storage unit 150 temporarily holds data stored in the ROM 602, data generated by each component, and the like. The storage unit 150 manages data necessary for realizing an arrangement of a CG model. For example, the storage unit 150 holds internal parameters of the camera, geometric information of a CG model, alignment information of the CG model, a camera image, a virtual image, information on a position and attitude of the camera, information on a position and attitude of a movable object, and marker information.

The internal parameters of the camera include information such as a focal length and a principal point of the imaging unit 103. The geometric information of a CG model include edge information of the CG model, a texture image of the CG model, and vertex positions of the CG model (a three-dimensional polygon) in a coordinate system (hereinafter, referred to as a “model coordinate system”) specific to the CG model. The alignment information of the CG model is information indicating a relationship between positions and attitudes of the CG model and a movable object on which the CG model is to be superimposed. More specifically, the alignment information is information on a matrix (4-by-4 matrix) for converting the position and attitude of the CG model in a global coordinate system into the position and attitude of the movable object when the CG model overlaps with the movable object in a mixed reality space. Since shapes, sizes, and the like of the CG model and the movable object do not completely match each other, the alignment information is information necessary for positioning the CG model and the movable object.

The virtual image is an image on which the CG model has been rendered. The information on the position and attitude of the camera is a parameter representing a position and attitude of the imaging unit 103 in the global coordinate system. The information on the position and attitude of the movable object is a parameter representing a position and attitude of the movable object in the global coordinate system.

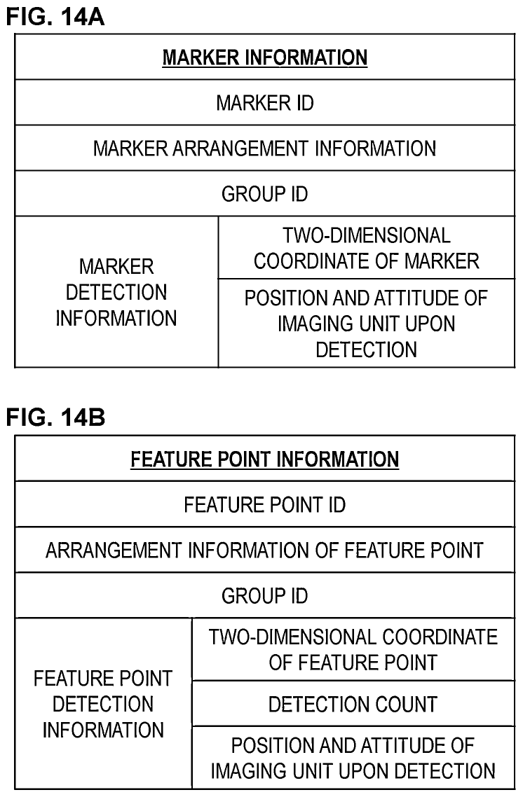

The marker information is information specific to a marker. As shown in FIG. 14A, the marker information holds a marker ID, marker arrangement information, a group ID, and marker detection information. The marker ID is a numerical value for identifying each marker. The marker arrangement information is information on a three-dimensional position (X, Y, Z) that defines a position of each marker. The marker arrangement information may be set beforehand or may be automatically generated during an MR experience. In addition, the marker arrangement information may include attitude information of the marker. The group ID is a numerical value indicating the movable object on which the marker is arranged. The group ID is a numerical value uniquely assigned to each movable object. The group ID is attribute information of each marker. The group ID may be set beforehand or automatically generated during an MR experience. The marker detection information includes information on a two-dimensional coordinate of the marker in the camera image and a position and attitude of the imaging unit 103 upon detection of the marker (upon imaging of the marker).

In the first embodiment, the experiencer 590 sets a different ID for each movable object in advance. In addition, the experiencer 590 assigns, to each marker, a group ID corresponding to the movable object on which the marker is arranged. In the first embodiment, the marker arrangement information indicates a three-dimensional position (X, Y, Z) of the marker in a reference coordinate system. In this case, one of a plurality of markers arranged on one movable object is determined as a reference marker and the “reference coordinate system” is a coordinate system of which an origin is a position of the reference marker.

The marker managing unit 155 stores marker information of the plurality of markers arranged in real space in the storage unit 150. In the first embodiment, the marker managing unit 155 acquires the marker arrangement information and the group ID of each marker according to settings by the experiencer 590. Therefore, the marker managing unit 155 operates as a position acquiring unit that acquires a three-dimensional position of each marker.

In addition, based on a camera image on which a marker appears, the marker managing unit 155 detects a two-dimensional coordinate of the marker in the camera image and a position and attitude of the imaging unit 103 upon detection of the marker (upon imaging of the marker). Furthermore, the marker managing unit 155 stores information on the two-dimensional coordinate of the marker in the camera image and information on the position and attitude of the imaging unit 103 upon detection of the marker as marker detection information in the storage unit 150.

A virtual image generating unit 160 renders a CG model based on information of the position and attitude of the camera, information on the position and attitude of the movable object, internal parameters of the camera, geometric information of the CG model, alignment information, and the like. In the first embodiment, the virtual image generating unit 160 acquires information on the position and attitude of the CG model in the global coordinate system based on the information on the position and attitude of the movable object and alignment information. The virtual image generating unit 160 renders a CG model in a coordinate system of the camera image based on information on the position and attitude of the CG model and information on the position and attitude of the camera in the global coordinate system. The virtual image generating unit 160 stores an image of the rendered CG model as a virtual image in the storage unit 150. Accordingly, when the virtual image and the camera image are composited, a virtual image in which the CG model overlaps with the movable object is generated.

The compositing unit 170 generates a composite image by compositing the camera image and the virtual image. The CG model overlaps with the movable object in the composite image (a mixed reality space represented by the composite image). In other words, the compositing unit 170 is also an arranging unit which arranges the CG model so as overlap with the movable object in the mixed reality space. The composite image is displayed on the display unit 110. Therefore, the compositing unit 170 can be described as controlling the display unit 110 so as to display the composite image.

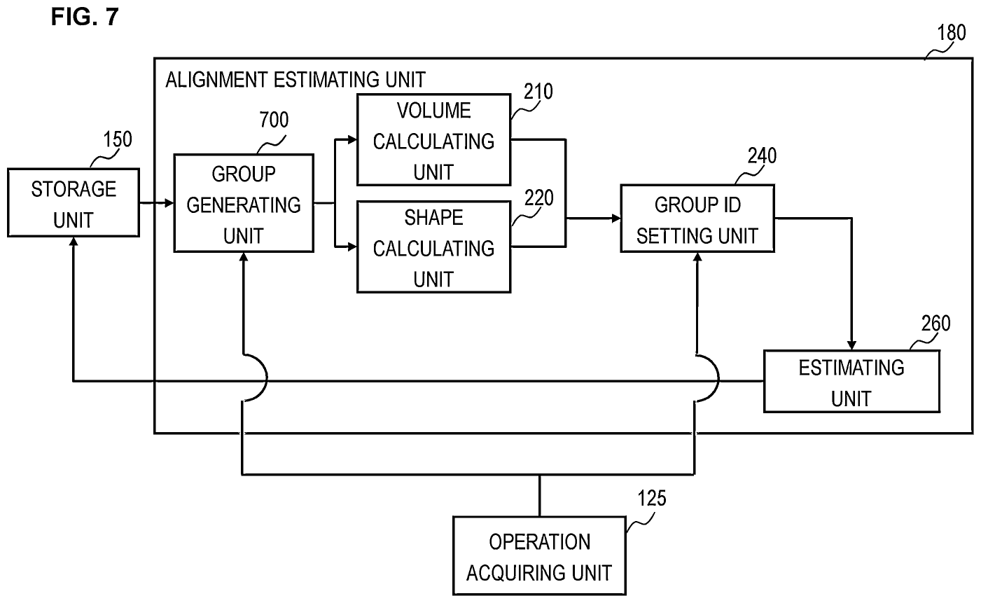

The alignment estimating unit 180 estimates (determines) alignment information so that the CG model overlaps with the movable object in the composite image based on geometric information of the CG model, marker information, and the like. An internal configuration of the alignment estimating unit 180 according to the first embodiment will be described later with reference to FIG. 7. The alignment information determined by the alignment estimating unit 180 is stored in the storage unit 150.

The camera estimating unit 190 estimates the position and attitude of the imaging unit 103 (the position and attitude of the imaging unit 103 in the global coordinate system) upon capturing the camera image. In the first embodiment, for example, the position and attitude of the imaging unit 103 may be estimated based on markers not arranged on the movable object (for example, markers 510F to 510H in FIG. 5) among the markers that appear in the camera image. The camera estimating unit 190 may estimate the position and attitude of the imaging unit 103 based on the marker arrangement information set beforehand and two-dimensional coordinates of the markers in the camera image. Instead of estimating the position and attitude of the imaging unit 103 based on markers, the camera estimating unit 190 may use a camera's estimation method of its own position and attitude such as SLAM.

The object estimating unit 195 estimates the position and attitude of the movable object upon capturing the camera image. The position and attitude of the movable object are estimated based on the plurality of markers arranged on the movable object. For example, the object estimating unit 195 may estimate the position and attitude of the movable object in a reference coordinate system of which an origin is a reference marker.

An example of specific processing by the object estimating unit 195 according to the first embodiment will be described with reference to FIG. 5. For example, the object estimating unit 195 specifies markers to which is assigned either the group ID of a movable object 520 or the group ID of a movable object 550 among the markers that appear in a camera image. In the example shown in FIG. 5, markers 510A to 510C are arranged on the movable object 520. Markers 510D to 510E are arranged on the movable object 550.

The object estimating unit 195 estimates a position of each of the markers 510A to 510C in a camera coordinate system based on, for example, marker information (positions in a reference coordinate system) of the markers 510A to 510C to which the group ID of the movable object 520 is assigned and the camera image. The camera coordinate system is a coordinate system based on the position and attitude of the imaging unit 103. The object estimating unit 195 converts the position of each of the markers 510A to 510C in the camera coordinate system into a position of a coordinate in accordance with a position (a position in the global coordinate system) of the imaging unit 103 estimated by the camera estimating unit 190. Accordingly, the object estimating unit 195 can estimate a position of each of the markers 510A to 510C in the global coordinate system. The object estimating unit 195 estimates the position and attitude of the movable object 520 in the global coordinate system based on the positions of the markers 510A to 510C in the global coordinate system. The position of the movable object 520 is, for example, a center position of a reference marker or a center of gravity position of the movable object 520. The attitude of the movable object 520 is, for example, an orientation from the marker 510A toward the marker 510C.

### Internal Configuration of Alignment Estimating Unit

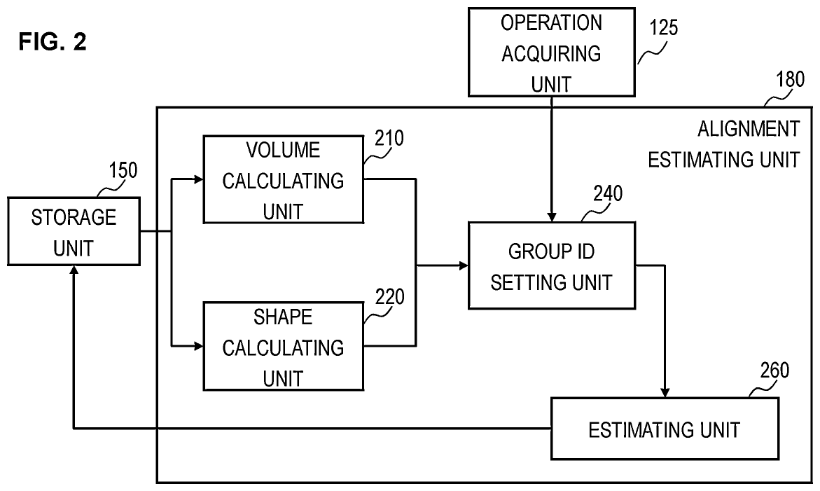

FIG. 2 is a block diagram showing an internal configuration of the alignment estimating unit 180. The alignment estimating unit 180 selects a CG model with a shape that approximately matches the shape of the movable object among a plurality of CG models stored in the storage unit 150 by referring to the plurality of markers arranged on the movable object. In addition, the alignment estimating unit 180 associates the movable object and the selected CG model with each other. Therefore, manual work (work to associate a movable object and a CG model with other) can be omitted and a reduction in preparation time of an MR experience can be achieved.

The alignment estimating unit 180 includes a volume calculating unit 210, a shape calculating unit 220, a group ID setting unit 240, and an estimating unit 260. Hereinafter, each component of the alignment estimating unit 180 will be described with respect to an example of determining alignment information of one CG model.

The volume calculating unit 210 acquires information on all vertex positions (hereinafter, referred to as a “vertex position group”) of a CG model (a three-dimensional polygon representing the CG model) from the geometric information of the CG model. The volume calculating unit 210 determines a rectangular parallelepiped with a smallest volume that includes the vertex position group. In addition, the volume calculating unit 210 determines a volume of the rectangular parallelepiped.

For example, the volume calculating unit 210 calculates a rectangular parallelepiped which has a side parallel to an X axis, a side parallel to a Y axis, and a side parallel to a Z axis of a model coordinate system and which has a smallest volume that includes the vertex position group. Next, the volume calculating unit 210 calculates a smallest rectangular parallelepiped (a rectangular parallelepiped which has a side parallel to the X axis, a side parallel to the Y axis, and a side parallel to the Z axis of the model coordinate system) which includes the vertex position group of the CG model after rotating the vertex position group by +10 degrees around the X axis as a rotational axis. The volume calculating unit 210 repeats the +10 degree-rotation and the calculation of a rectangular parallelepiped until the rotation angle around the X axis reaches +350 degrees to calculate a total of 36rectangular parallelepipeds.

In addition, the volume calculating unit 210 rotates the vertex position group of the CG model in +10-degree increments around the Y axis as a rotational axis in a similar manner to the rotation around the X axis as a rotational axis to calculate 35 smallest rectangular parallelepipeds. The volume calculating unit 210 rotates the vertex position group of the CG model in +10-degree increments around the Z axis as a rotational axis in a similar manner to the rotation around the X axis as a rotational axis to calculate 35 smallest rectangular parallelepipeds. Note that these rectangular parallelepipeds are rectangular parallelepipeds which have a side parallel to the X axis, a side parallel to the Y axis, and a side parallel to the Z axis of the model coordinate system.

The volume calculating unit 210 selects a smallest rectangular parallelepiped (hereinafter, referred to as a “CG rectangular parallelepiped”) among the 106 calculated rectangular parallelepipeds. In addition, the volume calculating unit 210 calculates a volume of the CG rectangular parallelepiped and sets the volume of the CG rectangular parallelepiped as a volume of the CG model. When a plurality of CG models are stored in the storage unit 150, the volume calculating unit 210 calculates the volumes of the plurality of CG models by a method similar to that described above. Note that any method may be used as the method of calculating a volume of a CG model.

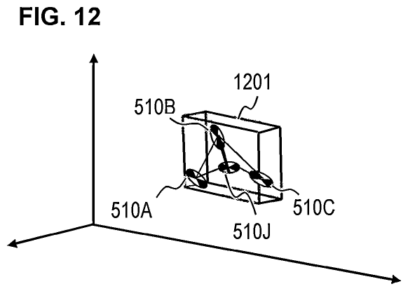

Furthermore, the volume calculating unit 210 detects three-dimensional positions of a plurality of markers belonging to one group ID based on marker arrangement information and group IDs. The volume calculating unit 210 calculates a volume of a smallest rectangular parallelepiped that includes the detected three-dimensional positions (three-dimensional position group) of the plurality of markers. The calculation of the volume of the rectangular parallelepiped is performed by a method similar to the calculation of the volume of the CG rectangular parallelepiped. Hereinafter, “a smallest rectangular parallelepiped that includes a plurality of markers belonging to one group ID (a plurality of markers arranged on one movable object)” will be referred to as a “marker rectangular parallelepiped”. In addition, the volume calculating unit 210 sets the volume of the marker rectangular parallelepiped as a volume of the movable object of the group ID corresponding to the marker rectangular parallelepiped. In FIG. 12, a marker rectangular parallelepiped 1201 entirely includes four markers 510, namely, the markers 510A, 510B, 510C, and 510J.

The shape calculating unit 220 calculates a ratio of sides (a ratio of a side in a width direction, a side in a height direction, and a side in a depth direction) of the CG rectangular parallelepiped. Furthermore, the shape calculating unit 220 calculates a ratio of sides of the marker rectangular parallelepiped for each group ID.

The group ID setting unit 240 associates, with a CG model, a group ID of the movable object with a shape that approximately matches a shape of the CG model. Specifically, the group ID setting unit 240 selects a marker rectangular parallelepiped having a volume that is closest to the volume of the CG rectangular parallelepiped of the CG model. In addition, the group ID setting unit 240 associates a group ID of the markers corresponding to the selected marker rectangular parallelepiped with the CG model.

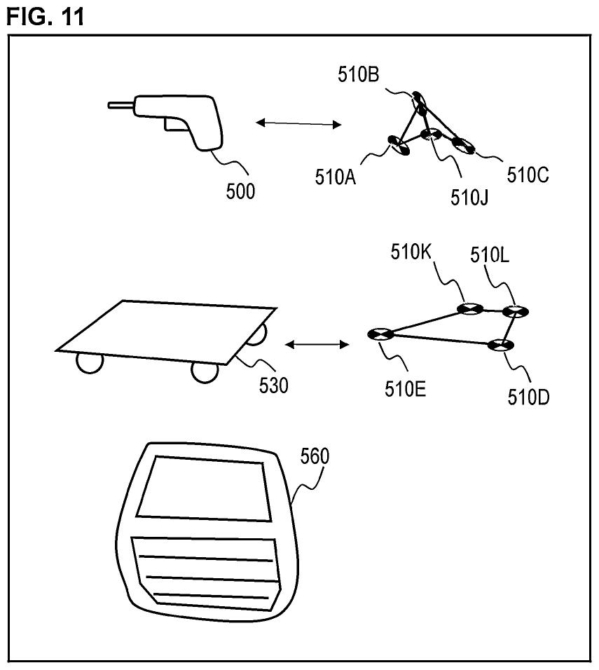

For example, let us assume a case where there are three CG models 500, 530, and 560 as shown in FIG. 11. It is assumed that, in this case, a group ID 1 is assigned to the markers 510A, 510B, 510C, and 510J and a group ID 2 is assigned to the markers 510D, 510E, 510K, and 510L.

The group ID setting unit 240 determines a “difference between a volume of a CG rectangular parallelepiped of the CG model 500 and a volume of a marker rectangular parallelepiped of the group ID 1” and a “difference between the volume of the CG rectangular parallelepiped of the CG model 500 and a volume of a marker rectangular parallelepiped of the group ID 2”. In addition, the group ID setting unit 240 associates a group ID corresponding to the smaller of the two differences with the CG model 500.

When a “marker rectangular parallelepiped of which a difference in volume from the volume of the CG rectangular parallelepiped of the CG model 500 is smaller than a prescribed threshold” exists in plurality, the group ID setting unit 240 determines that the CG model and the group ID cannot be associated with each other. As in the example shown in FIG. 11, when volumes of CG rectangular parallelepipeds of all CG models stored in the storage unit 150 significantly differ from each other, there is a high possibility that an accurate association can be made. However, when CG models of which sizes do not significantly differ from each other are stored, there are cases where an accurate association cannot be made by simply referring to the difference in volumes. In such a case, the group ID setting unit 240 attempts to associate the CG model and the group ID with each other based on information on the ratio of sides calculated by the shape calculating unit 220.

For example, the group ID setting unit 240 associates a group ID corresponding to a marker rectangular parallelepiped with a ratio of sides which minimizes a difference from the ratio of sides of the CG rectangular parallelepiped with the CG model. The “difference between the ratio of sides of the CG rectangular parallelepiped and the ratio of sides of the marker rectangular parallelepiped” refers to, for example, a sum of a “difference between lengths of sides in the height direction” and a “difference between lengths of sides in the depth direction” when lengths of sides in the width direction are normalized to “1”. For example, when the ratio of sides of the CG rectangular parallelepiped is width: height: depth=1:2:3 and the ratio of sides of the marker rectangular parallelepiped is width: height: depth=5:11:16, the ratio of sides of the marker rectangular parallelepiped is converted into width: height: depth=1:2.2:3.2. In addition, the difference between the two ratios is calculated as (2.2−2)+(3.2−3)=0.4.

Note that when there are no marker rectangular parallelepipeds with a ratio of sides of which a difference from the ratio of sides of the CG rectangular parallelepiped is equal to or smaller than a predetermined value, the group ID setting unit 240 may notify the experiencer 590 that there is no group ID that corresponds to the CG model. In this case, the group ID setting unit 240 may prompt the experiencer 590 to input a group ID that corresponds to the CG model. The experiencer 590 can input a group ID that corresponds to the CG model by operating the operation acquiring unit 125.

In addition, when the CG model and a group ID (a movable object with a shape that approximately matches that of the CG model) can be associated with each other in a more appropriate manner, the group ID setting unit 240 may use any method without being limited to associations based on volumes or ratios of sides. For example, a degree of similarity between shapes of two rectangular parallelepipeds may be calculated by any method and the CG model and a group ID may be associated with each other according to the degree of similarity. For example, the degree of similarity between the shapes of two rectangular parallelepipeds may be calculated by a method of determining eigenvectors by singular value decomposition with respect to a plurality of three-dimensional vertex groups and using an angular difference between a first eigenvector and a second eigenvector or the like as a degree of matching.

The estimating unit 260 calculates alignment information for converting the position and attitude of the CG model into the position and attitude of the movable object based on the CG model and the marker information of the group ID associated with the CG model. In other words, alignment information representing relative positions and attitudes of the CG model and the movable object of the group ID associated with the CG model is determined. Details of the processing by the estimating unit 260 will be described later. The estimating unit 260 stores the alignment information in the storage unit 150.

### Display Processing of Composite Image

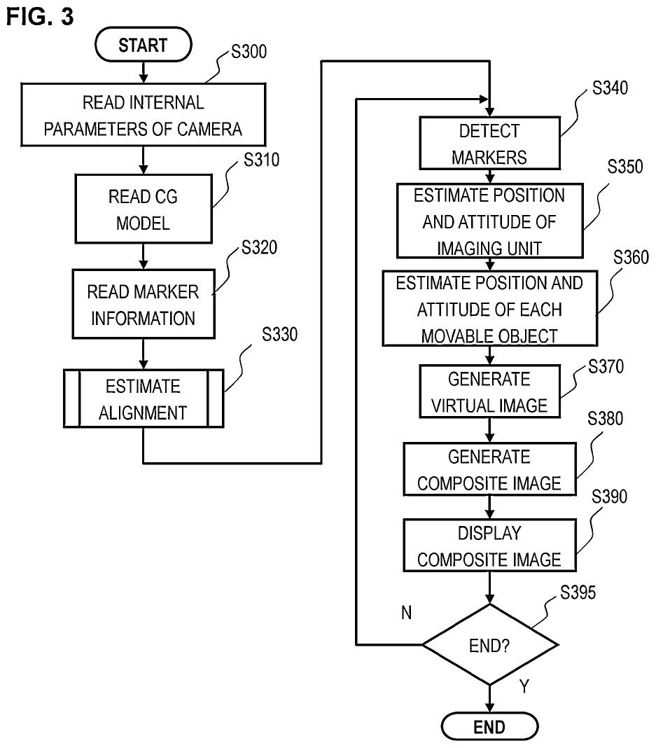

Details of display processing of a composite image according to the first embodiment will be described with reference to the flow chart in FIG. 3. It is assumed that, prior to start of the flow chart in FIG. 3, internal parameters of the camera, a CG model, marker information, and the like have been stored in the ROM 602. In addition, it is assumed that N-number of movable objects are arranged in real space and M-number of markers are arranged.

In step S300, the CPU 601 reads the internal parameters of the camera from the ROM 602 to the storage unit 150.

In step S310, the CPU 601 reads geometric information of the CG model from the ROM 602 to the storage unit 150.

In step S320, the CPU 601 reads marker information from the ROM 602 to the storage unit 150. In this case, the user has set a marker ID, marker arrangement information, and a group ID for each marker in advance. Therefore, the marker information stored in the ROM 602 includes at least a marker ID, marker arrangement information, and a group ID.

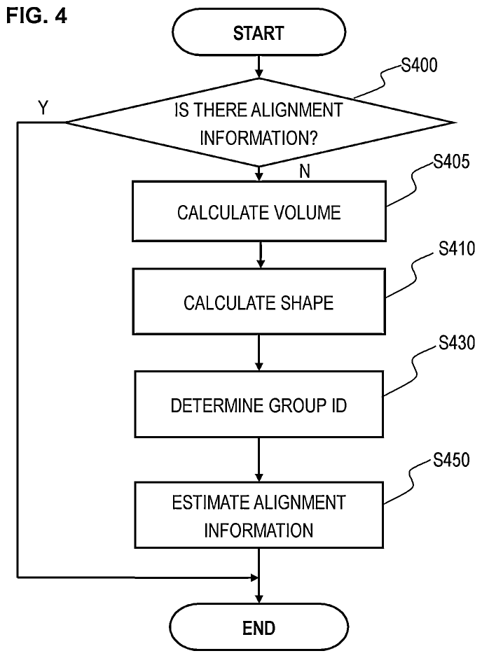

In step S330, the CPU 601 controls the alignment estimating unit 180 and estimates (determines) alignment information of N-number of CG models corresponding to the N-number of movable objects. The alignment estimating unit 180 estimates the alignment information of the N-number of CG models based on the internal parameters of the camera, the geometric information, and the marker information having been read to the storage unit 150. Details of the processing of step S330 will be provided later with reference to the flow chart in FIG. 4.

In step S340, the CPU 601 controls the marker managing unit 155 and detects M-number of markers from a camera image. Based on marker IDs stored in the storage unit 150, the marker managing unit 155 associates each of the M-number of detected markers with appropriate marker information. The marker managing unit 155 stores a two-dimensional coordinate of each of the M-number of markers in the camera image in marker detection information of the storage unit 150.

In step S350, the CPU 601 controls the camera estimating unit 190 and estimates the position and attitude of the imaging unit 103. In the first embodiment, the camera estimating unit 190 estimates the position and attitude of the imaging unit 103 in the global coordinate system based on, for example, a “two-dimensional coordinate in the camera image and marker arrangement information” of each of a plurality of markers not arranged on any of the N-number of movable objects.

In step S360, the CPU 601 controls the object estimating unit 195 and estimates the positions and attitudes of the N-number of movable objects on which markers are arranged. In the first embodiment, the object estimating unit 195 estimates the positions and attitudes of the movable objects in the global coordinate system based on “three-dimensional positions of the markers arranged on the movable objects (three-dimensional positions indicated by the marker arrangement information)” and the “position and attitude of the imaging unit 103”.

In step S370, the CPU 601 controls the virtual image generating unit 160 and renders N-number of CG models corresponding to the N-number of movable objects. The virtual image generating unit 160 generates a virtual image in which the N-number of CG models are rendered based on alignment information and the like. At this point, by using the alignment information, the virtual image is generated so that “each of the N-number of CG models overlaps with a movable object corresponding to the CG model in a mixed reality space represented by a composite image created by compositing the camera image and the virtual image”.

In step S380, the CPU 601 controls the compositing unit 170 and generates a composite image by compositing the camera image and the virtual image. At this point, each of the N-number of CG models is arranged so as to overlap with a movable object corresponding to the CG model in a mixed reality space represented by the composite image.

In step S390, the CPU 601 displays the composite image on the display unit 110. Accordingly, the composite image is presented to the experiencer 590 and the experiencer 590 is able to experience the mixed reality space.

In step S395, the CPU 601 determines whether or not an end instruction has been issued from the experiencer 590. When it is determined that an end instruction has been issued, the processing of the present flow chart is ended. When it is determined that an end instruction has not been issued, a transition is made to step S340 and processing of the present flow chart is executed with respect to a new camera image acquired from the imaging unit 103.

### Detailed Processing of Step S330

Details of the processing in step S330 will be described with reference to the flow chart in FIG. 4. In this case, the processing of the flow chart in FIG. 4 is to be executed for each CG model stored in the storage unit 150. Hereinafter, a single CG model to be subjected to processing of the flow chart in FIG. 4 will be referred to a “subject model”.

In step S400, the alignment estimating unit 180 determines whether or not the alignment information of the subject model is stored in the storage unit 150. When it is determined that the alignment information of the subject model is not stored, a transition is made to step S405. When it is determined that the alignment information of the subject model is stored, the processing of the present flow chart ends.

In step S405, the volume calculating unit 210 calculates a CG rectangular parallelepiped of the subject model. In addition, the volume calculating unit 210 calculates a marker rectangular parallelepiped for each group ID (in other words, each movable object). Hereinafter, it is assumed that there are L-number of group IDs (in other words, movable objects) and that L-number of marker rectangular parallelepipeds have been calculated. The volume calculating unit 210 calculates a volume of the CG rectangular parallelepiped of the subject model (=a volume of the subject model) and volumes of the L-number of marker rectangular parallelepipeds (=volumes of the L-number of movable objects).

In step S410, the shape calculating unit 220 calculates a ratio of sides of the CG rectangular parallelepiped of the subject model and ratios of sides of the L-number of marker rectangular parallelepipeds. Note that instead of executing the processing of step S405 and step S410, information on the volume and the ratio of sides of the CG rectangular parallelepiped of the subject model and information on the volumes and the ratios of sides of the L-number of marker rectangular parallelepipeds may be stored in the storage unit 150 in advance.

In step S430, the group ID setting unit 240 selects (determines) a group ID corresponding to the subject model based on the volume of the CG rectangular parallelepiped of the subject model and the volumes of the L-number of marker rectangular parallelepipeds. Alternatively, the group ID setting unit 240 may select (determine) the group ID corresponding to the subject model based on the ratio of sides of the CG rectangular parallelepiped of the subject model and the ratios of sides of the L-number of marker rectangular parallelepipeds.

In step S450, the estimating unit 260 estimates alignment information of the subject model based on a correspondence relationship between the subject model and the group ID, geometric information of the CG model, and marker information. Specifically, the estimating unit 260 selects a movable object corresponding to the subject model based on the correspondence relationship between the subject model and the group ID. In addition, based on the geometric information of the subject model and the marker information, the estimating unit 260 determines alignment information of the subject model indicating “relative positions and attitudes of the subject model and the movable object corresponding to the subject model”.

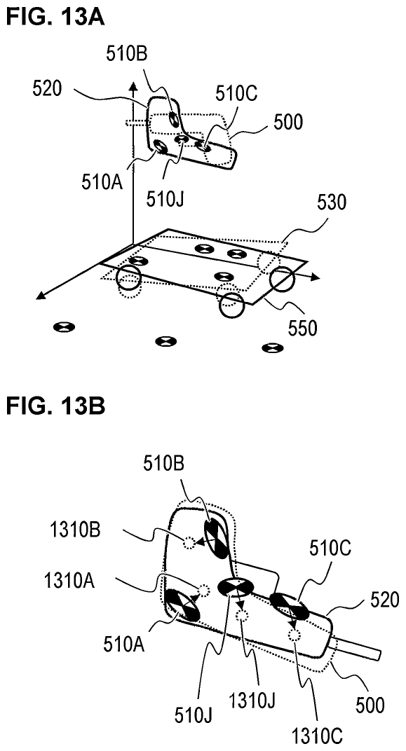

Hereinafter, processing by the estimating unit 260 will be described using a case where the CG model 500 shown in FIG. 13A is the subject model as an example. First, the estimating unit 260 selects the movable object 520 as a movable object corresponding to the CG model 500 based on the correspondence relationship between the subject model and the group ID. Note that a CG model and a movable object correspond to each other one-to-one. Therefore, “selecting the movable object 520 as a movable object corresponding to the CG model 500” can be interpreted as “selecting the CG model 500 as a CG model corresponding to the movable object 520 (a CG model with a shape that approximately matches a shape of the movable object 520)”.

Subsequently, the estimating unit 260 estimates a center of gravity position of the four markers 510 (the markers 510A, 510B, 510C, and 510J) that belong to the group ID of the CG model 500. In addition, the estimating unit 260 tentatively arranges the CG model 500 so that a reference position (for example, an origin of a reference coordinate system) of the CG model 500 is positioned at the estimated center of gravity position.

Next, with the position and attitude of the tentatively-arranged CG model 500 as an initial state, the estimating unit 260 calculates alignment information of a final CG model 500 using a steepest descent method or the like. FIG. 13B shows a schematic view of a case where the alignment information of the CG model 500 is calculated. In FIG. 13B, points 1310A, 1310B, 1310C, and 1310J indicate positions on a polygonal surface of the CG model 500.

In the first embodiment, the estimating unit 260 determines a distance between a position of each of the markers 510A, 510B, 510C, and 510J of the movable object 520 and the polygonal surface of the CG model 500. The estimating unit 260 calculates, using a known steepest descent method, a position and attitude of the CG model 500 that minimizes a sum of the distances between the positions of the respective markers and the polygonal surface. In other words, the position and attitude of the CG model 500 is calculated so as to minimize a sum of a distance between the marker 510A and the point 1310A, a distance between the marker 510B and the point 1310B, a distance between the marker 510C and the point 1310C, and a distance between the marker 510J and the point 1310J. Subsequently, the estimating unit 260 determines information on a matrix that converts the calculated position and attitude of the CG model 500 in the global coordinate system into the position and attitude of the movable object 520 in the global coordinate system as the alignment information of the CG model 500.

Note that the distance between the position of each marker and the polygonal surface of the CG model can be calculated by the processing described below. First, the estimating unit 260 selects a vertex position that is close to a position of a marker among the respective vertex positions of the CG model in the initial state. Next, the estimating unit 260 determines a formula of a polygonal plane that is close to the position of the marker from edge information including the selected vertex position. In addition, the estimating unit 260 calculates a distance between the position of the marker and the polygonal plane by a known method.

When using the steepest descent method, there is a possibility that the calculation may diverge and an optimal solution may not be calculated unless the initial state is approximated to a correct value. In consideration thereof, an initial position of the CG model is set so that, for example, a center of gravity position of positions of a plurality of markers belonging to a predetermined group ID and a center of gravity position of vertex positions of the CG model match each other. Note that as an initial attitude of the CG model, by rotating the attitude of the CG model by 0 degrees, 90 degrees, 180 degrees, and 270 degrees around the X axis, the Y axis, and the Z axis and calculating the distance described above for each attitude, the initial attitude of the CG model may be set according to a rotation angle that minimizes the distance.

In this manner, by executing the processing of the flow chart in FIG. 4 as many times as the number of CG models corresponding to the movable object, the alignment information of all CG models is estimated.

Note that the processing of the flow chart in FIG. 4 can be executed for each group ID. In this case, a single group ID to be subjected to the processing of the flow chart in FIG. 4 will be referred to as a “subject ID”. In this case, processing of step S400 is not executed. In addition, in step S405, the volume calculating unit 210 calculates volumes of CG rectangular parallelepipeds of all CG models stored in the storage unit 150 and calculates a volume of the marker rectangular parallelepiped of the movable object to which the subject ID is assigned. In step S410, the shape calculating unit 220 calculates ratios of sides of the CG rectangular parallelepipeds of all of the CG models stored in the storage unit 150 and a ratio of sides of the marker rectangular parallelepiped. In addition, in step S430, according to the volumes or the ratios of sides of the rectangular parallelepipeds, the group ID setting unit 240 selects a CG model corresponding to the subject ID (a CG model with a shape that approximately matches a shape of the movable object of the subject ID) from all of the CG models stored in the storage unit 150. The group ID setting unit 240 associates the selected CG model and the subject ID with each other. In step S450, when alignment information of the CG model selected by the group ID setting unit 240 is not stored in the storage unit 150, the alignment information of the CG model is determined.

According to the first embodiment, the model arranging apparatus which arranges a CG model so as to overlap with a movable object associates the movable object and the CG model with each other based on the CG model, marker information, and the like and estimates alignment information of the CG model. Therefore, an estimation of a relationship between a position and attitude of the movable object and a position and attitude of the CG model can be realized in a more efficient manner. In addition, the hassle and time involved in advance preparation of an MR experience of the experiencer 590 (user) can be reduced.

### Second Embodiment

In the first embodiment, the group ID and the marker arrangement information in marker information are set by the experiencer 590 in advance. In other words, the experiencer 590 sets (calibrates), beforehand, a positional relationship of a plurality of markers arranged (fixed) on a movable object and a correspondence relationship between the movable object and the plurality of markers arranged on the movable object.

On the other hand, a second embodiment is not premised on the arrangement information and the group ID of the marker information being set beforehand by the experiencer 590. In the second embodiment, the model arranging apparatus 100 sets a group ID and marker arrangement information regardless of the settings by the experiencer 590 (user). Therefore, an advance preparation time of the experiencer 590 can be further shortened and a burden on the experiencer 590 can be reduced.

A configuration of the model arranging apparatus 100 according to the second embodiment is similar to the configuration of the model arranging apparatus 100 according to the first embodiment described with reference to FIGS. 1 and 2. However, the second embodiment differs from the first embodiment in the processing by the marker managing unit 155 and the alignment estimating unit 180.

The marker managing unit 155 generates (acquires), in a mode of calculating a marker arrangement (hereinafter, referred to as an “arrangement calculation mode”), marker arrangement information based on marker detection information indicating a result of detecting markers from a plurality of camera images.

As the marker detection information, the storage unit 150 stores information related to the detection of each marker arranged in real space from a camera image. The marker managing unit 155 acquires information on two-dimensional coordinates of markers in each of the plurality of camera images and a position and attitude of the camera upon detection of the markers. The marker managing unit 155 executes known bundle adjustment based on the two-dimensional coordinates of the markers, the position and attitude of the camera upon detection the markers, and information on the internal parameters of the camera. A three-dimensional position (a three-dimensional position in a reference coordinate system) of each marker is estimated as a result of the bundle adjustment. The information on the three-dimensional positions of the markers is stored in the storage unit 150 as “marker arrangement information” in the marker information.

Bundle adjustment is premised on the markers attached to a movable object being stationary. Therefore, the display unit 110 may give the experiencer 590 a reminder beforehand by displaying a message that asks the experiencer 590 “not to move the movable object in the arrangement calculation mode”. In addition, once the processing of bundle adjustment is completed, the display unit 110 may notify the experiencer 590 that the movable object can be moved.

In addition, in the arrangement calculation mode, there may be cases where a marker arranged on a bottom surface of the movable object, a marker hidden behind the movable object, and the like cannot be detected from the camera images. When there are markers that are not detected in the arrangement calculation mode, the experiencer 590 may instruct the model arranging apparatus 100 to recalculate the marker arrangement via the operating unit 120. The model arranging apparatus 100 may make a transition to the arrangement calculation mode once again when such an instruction is issued. Furthermore, the marker managing unit 155 may execute bundle adjustment based on camera images reacquired by the imaging unit 103 having moved to a position where the markers can be detected.

Before executing the processing described in the first embodiment, the alignment estimating unit 180 calculates a “group ID of a marker” yet to be specified. FIG. 7 shows an internal configuration of the alignment estimating unit 180 according to the second embodiment. The alignment estimating unit 180 includes the volume calculating unit 210, the shape calculating unit 220, the group ID setting unit 240, and the estimating unit 260 but also a group generating unit 700.

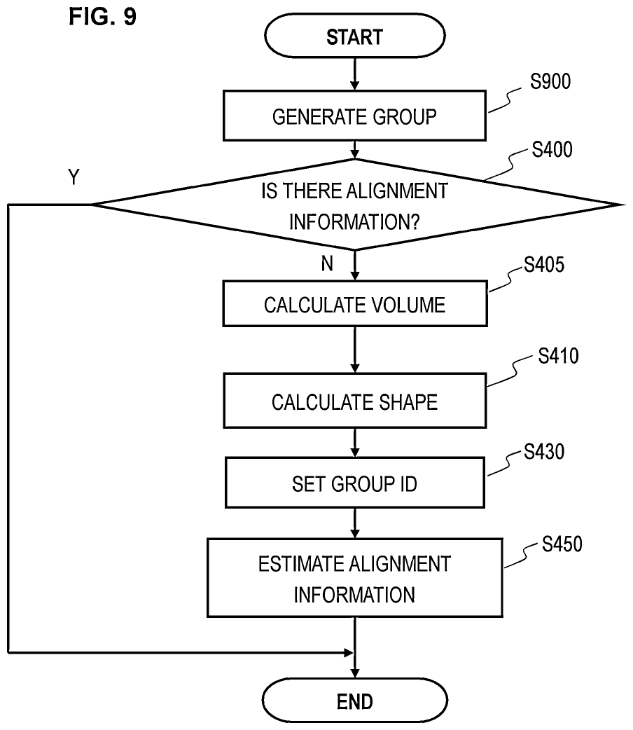

The group generating unit 700 detects a movable object that has been individually moved by the experiencer 590. The group generating unit 700 determines that all of the markers having moved together with the movable object are markers arranged on the movable object and sets (assigns) a new same group ID (a group ID of the moved movable object) to all of the markers having moved together with the movable object. Details of processing of setting the group ID will be described later using the flow chart shown in FIG. 9. When the experiencer 590 has moved the movable object, the experiencer 590 notifies the model arranging apparatus 100 of the fact that the movable object was moved via the operation acquiring unit 125.

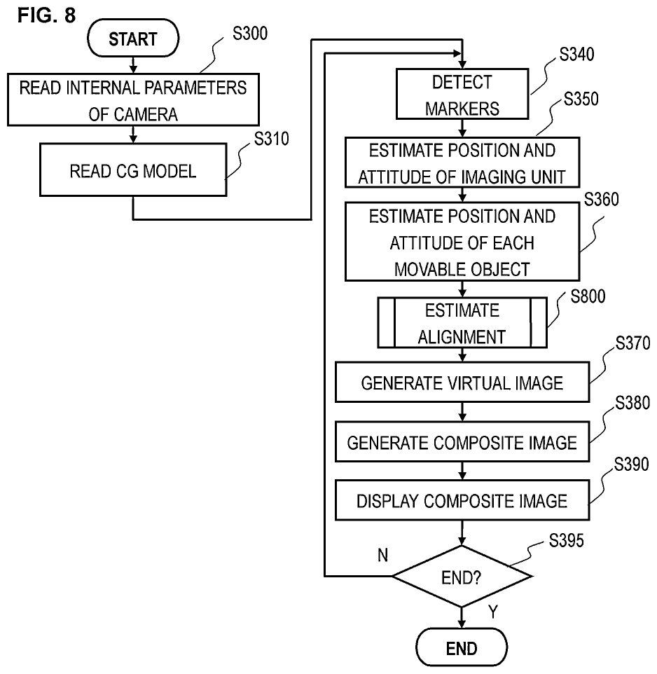

Display processing of a composite image according to the second embodiment will be described with reference to the flow chart in FIG. 8. In the processing of the flow chart in FIG. 8, since steps in which same processing as in the first embodiment is executed are denoted by same numbers, descriptions of such steps will be omitted. In the flow chart in FIG. 8, estimation processing of alignment (step S800) is executed after estimation processing of a position and attitude of each movable object (step S360).

In step S800, the CPU 601 controls the alignment estimating unit 180 and estimates alignment information of CG models based on the information stored in the storage unit 150. Details of the processing of step S800 will be described with reference to the flow chart in FIG. 9.

In the flow chart in FIG. 9, a step S900 has been added before step $400 as compared to the flow chart in FIG. 4 according to the first embodiment. Note that while the processing of steps S400 to S450 is executed for each CG model, the processing of step S900 is not processing that is executed for each CG model.

In step S900, when the group generating unit 700 receives an event that the movable object has moved from the operation acquiring unit 125, the group generating unit 700 compares the present positions of all markers with immediately-previous positions of all markers. In this case, since the marker arrangement information is calculated every time the movable object moves, the group generating unit 700 can calculate the present positions of all markers and the immediately-previous positions of all markers based on immediately-previous marker arrangement information and present marker arrangement information. Furthermore, the group generating unit 700 assigns a same group ID (a group ID of the moved movable object) to all markers of which a position has changed.

When a plurality of movable objects are arranged in real space, the experiencer 590 moves the movable objects, one at a time, and notifies the model arranging apparatus 100 of an event using the operating unit 120 every time a movable object is moved. Every time an event is received from the operation acquiring unit 125, the group generating unit 700 calculates the present positions of all markers and the immediately-previous positions of all markers and assigns a same group ID to all markers of which a difference between positions is larger than 0 (or a predetermined difference). Once a group ID is assigned to all of the markers arranged on all of the movable objects, a transition is made to step S400.

According to the second embodiment, the experiencer 590 need not assign a group ID to markers and need only move a movable object and notify the model arranging apparatus 100 of the movement of the movable object. Therefore, a burden of processing on the experiencer 590 can be reduced.

### Third Embodiment

In the first embodiment and the second embodiment, the model arranging apparatus 100 estimates alignment information of a CG model based on marker information. In a third embodiment, the model arranging apparatus 100 estimates alignment information also based on one or a plurality of feature points (a pattern that appears in a camera image or the like) that exist in a movable object.

Even when the number of markers arranged on a movable object is small, since a pattern on a movable object or the like can represent geometric information of the movable object in a similar manner to markers, the pattern on a movable object or the like can be handled as information for estimating a surface profile. In other words, the presence of a pattern on the movable object or the like increases an amount of information for estimating a shape and alignment information of a CG model. Therefore, even when a group ID corresponding to a CG model must be selected from a large number of group IDs, accuracy of association of the CG model and the group ID can be improved. In addition, in processing of estimating alignment information (processing of step S450), due to an increase in the number of samples of positions where a distance to the CG model is calculated, an improvement in estimation accuracy of alignment information is also conceivable.

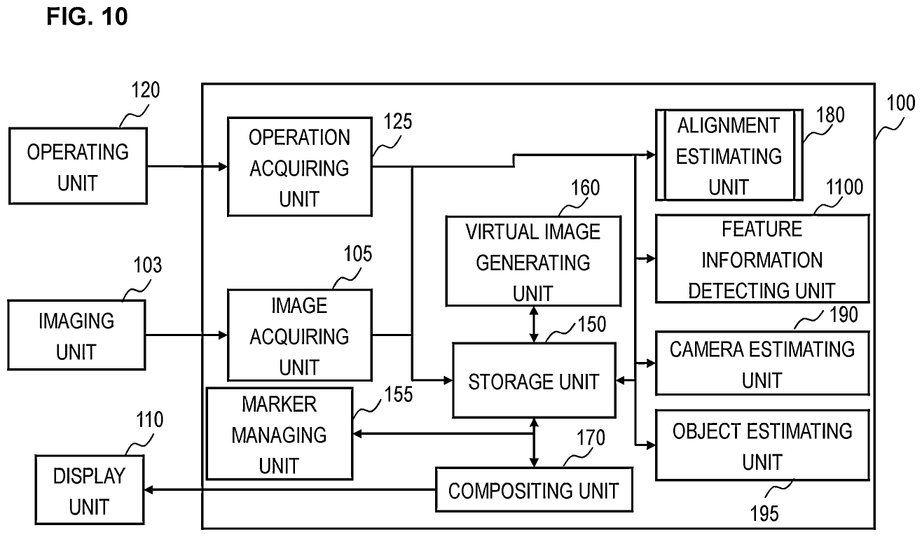

FIG. 10 shows functional blocks of the HMD 1 according to the third embodiment. The HMD 1 according to the third embodiment includes a feature information detecting unit 1100 together with the configuration of the HMD 1 according to the second embodiment.

The feature information detecting unit 1100 detects feature points in a movable object that appears in a camera image stored in the storage unit 150. The feature information detecting unit 1100 associates a “feature point ID” with a feature point and stores feature point information in the storage unit 150.

As shown in FIG. 14B, the feature point information includes a feature point ID, arrangement information of the feature point, a group ID, and feature point detection information. The feature point ID is a numerical value for identifying each feature point. The arrangement information of the feature point is information on a three-dimensional position (X, Y, Z) in a reference coordinate system that indicates a position of each feature point. The group ID is the same ID as the group ID included in marker information. The group ID is attribute information of each feature point. The feature point detection information includes information on a two-dimensional coordinate of the feature point in the camera image, a detection count of the feature point, and a position and attitude of the imaging unit 103 upon detection of the feature point.

In the third embodiment, the group generating unit 700 assigns a group ID to feature points in a similar manner to marker information. For example, in accordance with an event in which a movable object has moved, the group generating unit 700 may add a same new group ID (a group ID of the moved movable object) to all markers and all feature points of which a position has changed from immediately before the event.

Display processing of a composite image according to the third embodiment is similar to the display processing of a composite image according to the second embodiment. On the other hand, parts of processing of steps S900, S405, and S450 differ from the second embodiment.

In step S900, the group generating unit 700 assigns a group ID to pluralities of markers and feature points arranged on a movable object.

In step S405, the volume calculating unit 210 sets a marker rectangular parallelepiped that includes the three-dimensional positions of all markers and the three-dimensional positions of all feature points belonging to the same group ID and calculates a volume of the marker rectangular parallelepiped (a volume of the movable object). At this point, when the number of markers arranged on one movable object is small, calculating a marker rectangular parallelepiped as described in the first embodiment may increase a difference in volumes between the marker rectangular parallelepiped and the CG rectangular parallelepiped and may possibility prevent a correct association from being made. On the other hand, in the third embodiment, since the three-dimensional positions of the feature points are included in the marker rectangular parallelepiped in addition to the three-dimensional positions of the markers, an effect of reducing the difference in volumes between the marker rectangular parallelepiped and the CG rectangular parallelepiped to be associated with each other can be produced. Therefore, the possibility that a CG model and a group ID can be correctly associated with each other increases.

In step S450, the estimating unit 260 may calculate distances between positions of the feature points and a surface of the CG model in addition to distances between positions of the markers and the surface of the CG model. In addition, the estimating unit 260 estimates alignment information indicating a relationship of relative positions and attitudes between the CG model and the movable object which minimizes a sum of distances between respective “positions of all markers and positions of all feature points” and the “surface of the CG model”.

However, since a detected position of a feature point may contain error due to recognition in image processing, there is a possibility that the detected position of the feature point may be deviated from the position of the surface of the movable object. Therefore, the alignment estimating unit 180 may only use feature points of which a detection count (the number of times the feature point had been detected from a camera image) which is stored in the feature point detection information exceeds a predetermined number of times among the plurality of feature points.

According to the third embodiment, since alignment information can be estimated based on not only markers but also feature points of a movable object, the alignment information can be estimated with higher accuracy. In addition, using the feature points of a movable object also enables a CG model and a group ID to be accurately associated with each other.

In each of the embodiments described above, an HMD (a video see-through-type HMD) which displays a composite image representing a mixed reality space by compositing a virtual image on a captured image has been described. However, when the HMD is an optical see-through-type HMD in which real space is visible through a display surface, the HMD may simply display a virtual image on the display surface. Even in this case, the user can view a mixed reality space in which a CG model is arranged in real space. In other words, even in this case, the HMD can arrange a CG model so as to overlap with a movable object in the mixed reality space.

According to the present invention, an estimation of a relationship between a position and attitude of an object and a position and attitude of a CG model can be realized in a more efficient manner.

While the present invention has been described in detail based on preferred embodiments thereof, the present invention is not limited to the specific embodiments and various modes without departing from the scope of the invention are also included in the present invention. Parts of the embodiments described above may be appropriately combined with each other.

In addition, “advance to step S1 when A is B or more but advance to step S2 when A is smaller (lower) than B” in the description presented above may be replaced with “advance to step S1 when A is larger (higher) than B but advance to step S2 when A is B or less”. Conversely, “advance to step S1 when A is larger (higher) than B but advance to step S2 when A is B or less” may be replaced with “advance to step S1 when A is B or more but advance to step S2 when A is smaller (lower) than B”. Therefore, unless an inconsistency arises, “A or more” may be replaced with “larger (higher; longer; more) than A” and “A or less” may be replaced with “smaller (lower; shorter; less) than A”. In addition, “larger (higher; longer; more) than A” may be replaced with “A or more” and “smaller (lower; shorter; less) than A” may be replaced with “A or less”.

Note that the above-described various types of control may be processing that is carried out by one piece of hardware (e.g., processor or circuit), or otherwise.

Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-180060, filed on Oct. 19, 2023, which is hereby incorporated by reference herein in its entirety.

What is claimed is:

1. An arranging apparatus which arranges a CG model in a specific space so that the CG model overlaps with an object, the arranging apparatus comprising one or more processors and/or circuitry configured to:
execute position acquisition processing of acquiring three-dimensional positions of a plurality of markers arranged on a first object;
execute selection processing of selecting a first CG model from a plurality of CG models based on the three-dimensional positions of the plurality of markers;
execute estimation processing of estimating a relationship of relative positions and attitudes between the first CG model selected by the selection processing and the first object based on the three-dimensional positions of the plurality of markers; and
execute arrangement processing of arranging the first CG model in the specific space so as to overlap with the first object based on the relationship of positions and attitudes estimated by the estimation processing.

2. The arranging apparatus according to claim 1, wherein
in the selection processing, the first CG model of which a shape approximately matches a shape of the first object is selected from the plurality of CG models based on the three-dimensional positions of the plurality of markers.

3. The arranging apparatus according to claim 1, wherein
in the selection processing, the first CG model is selected based on a volume of the first object and volumes of the plurality of CG models.

4. The arranging apparatus according to claim 3, wherein
in the selection processing, 1) a volume of a smallest rectangular parallelepiped that includes the plurality of markers is calculated as the volume of the first object based on the three-dimensional positions of the plurality of markers, and 2) a volume of a smallest rectangular parallelepiped that includes each vertex of the CG model is calculated as the volume of the CG model.

5. The arranging apparatus according to claim 1, wherein
in the selection processing, the first CG model is selected based on a ratio of sides of a smallest rectangular parallelepiped that includes the plurality of markers and a ratio of sides of a smallest rectangular parallelepiped that includes each vertex of the CG model.

6. The arranging apparatus according to claim 1, wherein
in the estimation processing, a relationship of relative positions and attitudes between the first CG model and the first object is estimated which minimizes a sum of respective distances between a polygonal surface of the first CG model and a plurality of markers arranged on the first object.

7. The arranging apparatus according to claim 1, wherein
in the position acquisition processing, the three-dimensional positions of the plurality of markers are acquired based on an image capturing the first object taken by an imaging apparatus.

8. The arranging apparatus according to claim 7, wherein
determination processing of determining, when the first object moves, all markers which have moved together with the first object as the plurality of markers arranged on the first object is executed.

9. The arranging apparatus according to claim 1, wherein
in the position acquisition processing, the three-dimensional positions of the plurality of markers and three-dimensional positions of one or a plurality of feature points in the first object are acquired based on an image capturing the first object taken by an imaging apparatus, and
in the estimation processing, a relationship of relative positions and attitudes between the first CG model selected by the selection processing and the first object is estimated based on the three-dimensional positions of the plurality of markers and the three-dimensional positions of the one or the plurality of feature points.

10. The arranging apparatus according to claim 9, wherein
in the position acquisition processing, the three-dimensional positions of the plurality of markers and the three-dimensional positions of the one or the plurality of feature points in the first object are acquired based on a plurality of images capturing the first object taken by the imaging apparatus, and
in the estimation processing, a relationship of relative positions and attitudes between the first CG model selected by the selection processing and the first object is estimated based on three-dimensional positions of feature points of which a detection count exceeds a predetermined number of times among the one or the plurality of feature points and on the three-dimensional positions of the plurality of markers.

11. The arranging apparatus according to claim 1, wherein
display control processing of controlling a display apparatus to display an image of the first CG model is executed.

12. The arranging apparatus according to claim 11, wherein
image acquisition processing of acquiring a captured image from an imaging apparatus is further executed,
the display apparatus is a video see-through-type HMD (head mounted display) including the imaging apparatus, and
in the display control processing, a composite image that composites the captured image and an image of the first CG model is displayed on the display apparatus.

13. The arranging apparatus according to claim 11, wherein
the display apparatus is an optical see-through-type HMD (head mounted display).

14. A display apparatus which displays an image of a CG model so that the CG model overlaps with an object, the display apparatus comprising one or more processors and/or circuitry configured to:
execute position acquisition processing of acquiring three-dimensional positions of a plurality of markers arranged on a first object;
execute selection processing of selecting a first CG model from a plurality of CG models based on the three-dimensional positions of the plurality of markers;
execute estimation processing of estimating a relationship of relative positions and attitudes between the first CG model selected by the selection processing and the first object based on the three-dimensional positions of the plurality of markers;
execute arrangement processing of arranging the first CG model so as to overlap with the first object based on the relationship of positions and attitudes estimated by the estimation processing; and
execute display processing of displaying an image of the first CG model arranged by the arrangement processing.

15. An arranging method of arranging a CG model in a specific space so that the CG model overlaps with an object, the arranging method comprising:
executing position acquisition processing of acquiring three-dimensional positions of a plurality of markers arranged on a first object;
executing selection processing of selecting a first CG model from a plurality of CG models based on the three-dimensional positions of the plurality of markers;
executing estimation processing of estimating a relationship of relative positions and attitudes between the first CG model selected in the selection processing and the first object based on the three-dimensional positions of the plurality of markers; and
executing arrangement processing of arranging the first CG model in the specific space so as to overlap with the first object based on the relationship of positions and attitudes estimated in the estimation processing.

16. A non-transitory computer readable medium that stores a program, wherein the program causes a computer to execute an arranging method of arranging a CG model in a specific space so that the CG model overlaps with an object,
the arranging method comprising:
executing position acquisition processing of acquiring three-dimensional positions of a plurality of markers arranged on a first object;
executing selection processing of selecting a first CG model from a plurality of CG models based on the three-dimensional positions of the plurality of markers;
executing estimation processing of estimating a relationship of relative positions and attitudes between the first CG model selected in the selection processing and the first object based on the three-dimensional positions of the plurality of markers; and
executing arrangement processing of arranging the first CG model in the specific space so as to overlap with the first object based on the relationship of positions and attitudes estimated in the estimation processing.
